(19) United States
(12) Patent Application Publication
(10) Pub. No.: US 2014/0363088 A1
(43) Pub. Date: Dec. 11, 2014

(54) METHOD OF ESTABLISHING DATABASE INCLUDING HAND SHAPE DEPTH IMAGES AND METHOD AND DEVICE OF RECOGNIZING HAND SHAPES

(71) Applicant: KOREA INSTITUTE OF SCIENCE AND TECHNOLOGY, Seoul (KR)

(72) Inventors: Young-woon CHA, Seoul (KR); Hwasup LIM, Hwaseong-si (KR); Sang Chul AHN, Seoul (KR); Hyoung Gon KIM, Seoul (KR)

(73) Assignee: KOREA INSTITUTE OF SCIENCE AND TECHNOLOGY, Seoul (KR)

(21) Appl. No.: 14/294,195

(22) Filed: Jun. 3, 2014

(30) Foreign Application Priority Data
Jun. 7, 2013 (KR) 10-2013-0065378

(51) Int. Cl. G06F 17/30; G06K 9/46; G06K 9/00

(52) U.S. Cl. CPC G06F 17/30256; G06K 9/00355; G06K 9/4604
USPC 382/195; 707/736

(57) ABSTRACT

A method of recognizing a hand shape by using a database including a plurality of hand shape depth images includes receiving a motion of a user, extracting a hand shape depth image of the user from the received motion, normalizing a size and depth values of the extracted hand shape depth image to conform to criteria of a size and depth values of the hand shape depth images stored in the database, and detecting from the database a hand shape depth image corresponding to the normalized hand shape depth image. It is possible to detect a hand shape depth image in a rapid and accurate way with the disclosed method.

### DESCRIPTION ABOUT NATIONAL RESEARCH AND DEVELOPMENT SUPPORT

This study was supported by the Fundamental Technology Development Program (Global Frontier Program) of Ministry of Science, ICT and Future Planning, Republic of Korea (Center of Human-centered Interaction for Coexistence, Project No. 2010-0029752) under the superintendence of Korea Institute of Science and Technology.

### CROSS-REFERENCE TO RELATED APPLICATION

This application claims priority to Korean Patent Application No. 10-2013-0065378, filed on Jun. 7, 2013, and all the benefits accruing therefrom under 35 U.S.C. §119, the contents of which in its entirety are herein incorporated by reference.

### BACKGROUND

1. Field

Embodiments of the present disclosure relate to a method of establishing a database including hand shape depth images and a method and device of recognizing hand shapes, and more particularly, to a method of establishing a database including hand shape depth images and a method and device of recognizing hand shapes, which allows more rapid and accurate recognition of a hand shape of a user.

2. Description of the Related Art

A human-computer interface (HCI) is a technology for improving all behaviors between humans and computers for a certain purpose or interactions between a computer system and a computer user. The HCI has been developed in and applied to various fields such as computer graphics (CG), operating systems (OS), human factors, human engineering, industrial engineering, cognitive psychology, computer science, etc. When a human works with a computer and commands the computer to execute the work with a language perceptible by the computer, the computer shows an execution result to the human. The HCI has been mainly developed in relation to how humans transfer commands to a computer. For example, interactions between a human and a computer have been made at an initial stage by using a keyboard and a mouse, followed by human body touch recognition. In addition, human motion recognition is being used, which is more developed in comparison to the touch recognition, and the technology for motion recognition is being developed further for better recognition accuracy and rate.

Among such motion recognition, a technology for recognizing a hand shape of a human may be a part of the HCI. In an existing hand shape recognizing technology, a user should wear a glove apparatus on his hand. However, the method using the globe apparatus demands the apparatus to be calibrated whenever a user wearing the globe apparatus changes, and thus a method not using such a globe apparatus has been proposed as a solution thereto.

The method not using a globe apparatus is generally classified into a hand shape recognizing method using a color image and a hand shape recognizing method using a depth image. In the hand shape recognizing method using a color image, the hand is expressed with a single color (a skin color or beige), and thus this method may extract just a contour of the hand as a feature and may not recognize the hand shape in detail. Meanwhile, in the hand shape recognizing method using a depth image, features of the hand inside the contour of the hand shape may be extracted, which ensures more reliable hand shape recognition. In order to execute the hand shape recognizing method using a depth image, an initial hand shape of a user is detected, and then a motion of the user is tracked to recognize the hand shape. For tracking, the motion of the user is photographed as multiple images at very short time intervals, and the final hand shape of the user is expressed by tracking the difference between the multiple images. However, when tracking each image, an error may occur, and such an error may be accumulated to cause an incorrect location to be tracked (a draft phenomenon). If tracking fails as described above, a reinitialization process should be performed.

### SUMMARY OF THE INVENTION

An aspect of the present disclosure is directed to constructing a database storing hand shape depth images to improve a hand shape recognition rate by detecting a hand shape which is input by a user from the database without using a tracking method.

Also, an aspect of the present disclosure is directed to improving a hand shape recognition accuracy by reproducing a hand shape depth image to be identical to the input hand shape, by using hand joint angles and the hand shape depth images stored in the database which are similar to the input hand shape.

Other objects and characteristics of the present disclosure will be described in the following embodiments and the appended claims.

To accomplish the objectives of the present disclosure, a method of establishing a database including hand shape depth images according to an embodiment of the present invention includes receiving a motion of a user; extracting a hand shape depth image and hand joint angles of the user from the received motion; normalizing a size and depth values of the extracted hand shape depth image; and storing the normalized hand shape depth image with corresponding hand joint angles extracted.

Also, the method of establishing the database including hand shape depth images further includes normalizing a direction of the extracted hand shape depth image.

Also, said extracting of the hand shape depth image and the hand joint angles of the user from the received motion extracts a figure including a hand region of the user from a depth image of the motion of the user to obtain the hand shape depth image.

Also, said normalizing includes determining a size of the hand shape depth image by using at least one of a diameter, a length of a side and a diagonal length of the extracted figure; comparing the size of the hand shape depth image with a preset size; and adjusting the size of the hand shape depth image to the preset size by enlargement or reduction.

Also, said normalizing includes adjusting a smallest depth value in the extracted hand shape depth image to a specific value so that the stored hand shape depth images have the same smallest depth value; and adjusting other depth values in the hand shape depth image according to an adjustment degree of the smallest depth value.

Meanwhile, a method of recognizing a hand shape by using a database including a plurality of hand shape depth images according to another embodiment of the present invention includes receiving a motion of a user; extracting a hand shape depth image of the user from the received motion; normalizing a size and depth values of the extracted hand shape depth image to conform to criteria of a size and depth values of the hand shape depth images stored in the database; and detecting from the database a hand shape depth image corresponding to the normalized hand shape depth image.

Also, the method of recognizing the hand shape further includes normalizing a direction of the extracted hand shape depth image to conform to a direction criterion of the hand shape depth images stored in the database.

Also, said extracting of the hand shape depth image of the user from the received motion detects an image having depth values within a preset range from the depth image of the motion of the user and extracts a figure including a hand region of the user as the hand shape depth image.

Also, the hand shape depth images stored in the database are normalized to have a preset size, and the depth values of the hand shape depth images stored in the database are normalized based on a smallest depth value of each hand shape depth image.

Also, said normalizing includes: normalizing the size of the hand shape depth image by adjusting a size of the figure to the preset size by enlargement or reduction; and normalizing the depth values of the hand shape depth image by adjusting all depth values of the figure so that a smallest depth value of the figure is identical to the smallest depth value of the hand shape depth images stored in the database.

Also, said detecting of the hand shape depth image corresponding to the normalized hand shape depth image from the database detects from the database a hand shape depth image with depth values whose difference from the depth values of the normalized hand shape depth image is within a preset range.

Also, said detecting of the hand shape depth image corresponding to the normalized hand shape depth image from the database determines a difference in depth values between the normalized hand shape depth image and the hand shape depth images stored in the database based on at least one of depth values, a gradient direction and a gradient magnitude.

Also, said detecting of the hand shape depth image corresponding to the normalized hand shape depth image from the database determines the difference in the depth values by comparing depth values of pixels in the normalized hand shape depth image and depth values of pixels in the hand shape depth images stored in the database corresponding to the pixels in the normalized hand shape depth image.

Also, said detecting of the hand shape depth image corresponding to the normalized hand shape depth image from the database includes: calculating a direction and a magnitude of a gradient of the normalized hand shape depth image and directions and magnitudes of gradients of the hand shape depth images stored in the database; comparing at least one of the directions and the magnitudes between the gradient of the normalized hand shape depth image and the gradients of the hand shape depth images stored in the database; and detecting from the database a hand shape depth image with gradients whose direction or magnitude has a difference from the direction or the magnitude of the gradient of the normalized hand shape depth image within the preset range.

Also, the database includes information about hand joint angles corresponding to each hand shape depth image, and the method further comprises elaborating the detected hand shape depth image by using information about hand joint angles corresponding to the detected hand shape depth image.

Meanwhile, a device of recognizing a hand shape according to another embodiment of the present invention includes: an input unit configured to receive a motion of a user; a depth image extracting unit configured to extract a hand shape depth image of the user from the received motion; a database storing a plurality of hand shape depth images; a depth image normalizing unit configured to normalize a size and depth values of the extracted hand shape depth image to conform to criteria of a size and depth values of the hand shape depth images stored in the database; and a corresponding depth image detecting unit configured to detect from the database a hand shape depth image corresponding to the normalized hand shape depth image.

Also, the depth image normalizing unit further normalizes a direction of the extracted hand shape depth image to conform to a direction criterion of the hand shape depth images stored in the database.

Also, the depth image extracting unit detects an image having depth values within a preset range from the depth image of the motion of the user and extracts a figure including a hand region of the user as the hand shape depth image.

Also, the hand shape depth images stored in the database are normalized to have a preset size, and the depth values of the hand shape depth images stored in the database are normalized based on a smallest depth value of each hand shape depth image.

Also, the depth image normalizing unit includes: a size normalizing unit configured to normalize the size of the hand shape depth image by adjusting a size of the figure to the preset size by enlargement or reduction; and a depth value normalizing unit configured to normalize the depth values of the hand shape depth image by adjusting all depth values of the figure so that a smallest depth value of the figure is identical to the smallest depth value of the hand shape depth images stored in the database.

Also, the corresponding depth image detecting unit detects from the database a hand shape depth image with depth values whose difference from the depth values of the normalized hand shape depth image is within a preset range.

Also, the corresponding depth image detecting unit determines a difference in depth values between the normalized hand shape depth image and the hand shape depth images stored in the database based on at least one of depth values, a gradient direction and a gradient magnitude.

Also, the corresponding depth image detecting unit determines the difference in the depth values by comparing depth values of pixels in the normalized hand shape depth image and dep values of pixels in the hand shape depth images stored in the database corresponding to the pixels in the normalized hand shape depth image.

Also, the corresponding depth image detecting unit performs: calculating a direction and a magnitude of a gradient of the normalized hand shape depth image and directions and magnitudes of gradients of the hand shape depth images stored in the database; comparing at least one of the directions and the magnitudes between the gradient of the normalized hand shape depth image and the gradients of the hand shape depth images stored in the database; and detecting from the database a hand shape depth image whose gradient has a direction or a magnitude within the preset range.

Also, the database includes information about hand joint angles corresponding to each stored hand shape depth image, and the device further comprises a depth image elaborating unit configured to elaborate the detected hand shape depth image by using information about hand joint angles corresponding to the detected hand shape depth image.

In at least one embodiment of the present disclosure configured as above, when recognizing a hand shape of a user, a database is constructed to include depth images of hand shapes, and a hand shape is recognized by using the database, thereby ensuring more rapid and accurate recognition in comparison to existing technologies. In the existing technologies, the detecting process takes a long time, and an error is highly likely to occur in a tracking process. However, in an embodiment of the present disclosure, since a hand shape most similar to the input hand shape is detected from the database, the hand shape may be recognized rapidly. Further, since depth images stored in the database are classified into a plurality of groups in a tree structure, when detecting a depth image, it is sufficient to search a part of data according to the tree structure without searching the entire data. Therefore, the hand shape recognition rate may be further improved. In addition, in an embodiment of the present disclosure, a hand shape depth image may be provided more accurately by using information about depth images and hand joint angles stored in the database.

### BRIEF DESCRIPTION OF THE DRAWINGS

FIG. 1 is a block diagram showing a system for establishing a database including hand shape depth images according to the first embodiment of the present disclosure.

FIG. 2 shows an image in which a hand region depth image is selected from an entire depth image by a hand shape depth image extracting unit according to the first embodiment of the present disclosure.

FIG. 3 is a diagram showing the structure of a database including hand shape depth images according to the first embodiment of the present disclosure.

FIG. 4 is a block diagram showing a device of recognizing a hand shape according to the second embodiment of the present disclosure.

FIG. 5 shows a hand shape depth image normalized by a depth image normalizing unit according to the second embodiment of the present disclosure.

FIG. 6 shows a hand shape depth image detected by a corresponding depth image detecting unit according to the second embodiment of the present disclosure.

FIG. 7 is a final output image elaborated by a depth image elaborating unit and displayed according to the second embodiment of the present disclosure.

FIG. 8 is a diagram for illustrating a process for generating a feature vector.

### DETAILED DESCRIPTION OF THE INVENTION

Hereinafter, a method of establishing a database including hand shape depth images and a method and device of recognizing hand shapes according to an embodiment of the present disclosure will be described in detail with reference to the accompanying drawings.

In the specification, similar or identical reference signs are endowed to similar or identical components throughout various embodiments, and their descriptions will be referred to the first description. In addition, it should be understood that the shape, size and regions, and the like, of the drawing may be exaggerated or reduced for clarity.

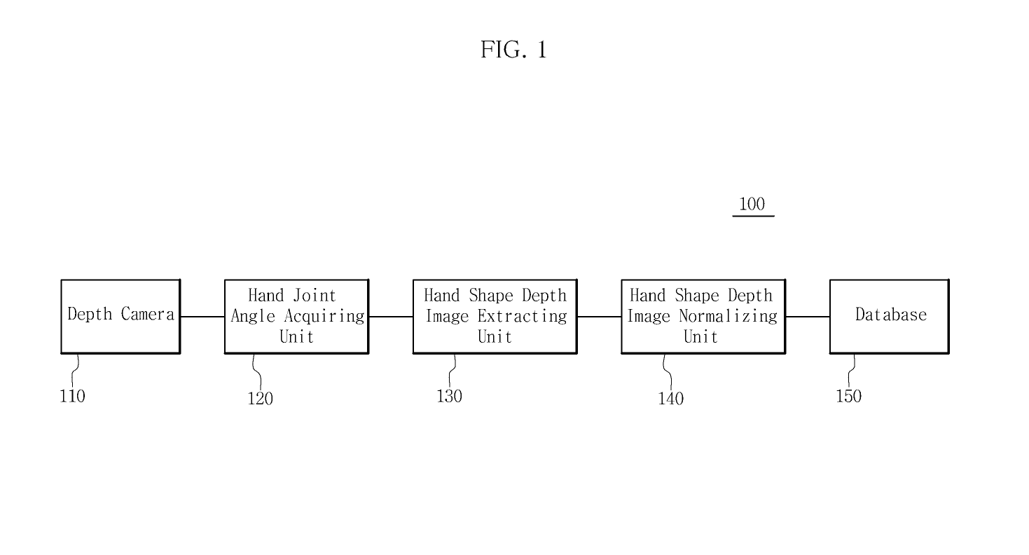

First, a system for establishing a database including hand shape depth images and a method of constructing the database according to the first embodiment of the present disclosure will be described with reference to FIGS. 1 to 3.

Referring to FIG. 1, a system 100 for establishing a database 150 including hand shape depth images includes a depth camera 110, a hand joint angle acquiring unit 120, a hand shape depth image extracting unit 130, a hand shape depth image normalizing unit 140 and a database 150.

The depth camera 110 measures a distance from the camera to an object by using an infrared sensor and outputs an image showing the distance. The depth information acquired by the depth camera 110 may be obtained in real time advantageously. The depth camera 110 extracts depth information of a subject disposed at the front. Therefore, if a user makes a hand shape having specific hand joint angles in front of the depth camera 110, the depth camera 110 extracts depth information of a user body included in an angle of the depth camera 110, including a hand region of the user. In an embodiment, a user makes a hand shape having certain joint angles, and at this time, the depth camera 110 extracts depth information of the user in relation to the certain joint angles, which is acquired by the hand joint angle acquiring unit 120 described below.

The hand joint angle acquiring unit 120 acquires information about the hand joint angles made by the user. Here, the hand joint means a joint between bones of the hand of the user. In detail, every finger except for the thumb is composed of a single metacarpal bone and three phalanges, wherein a metacarpophalangeal joint is present between the metacarpal bone and the phalanges, and proximal and distal joints are also present among the phalanges. For example, a joint between knuckles is also included in the hand joint. Therefore, the hand joint angles are present between two knuckles and have a plurality of values.

The hand shape depth image extracting unit 130 extracts a depth image of the hand region from the entire depth image by using the depth information acquired by the depth camera 110. Since the depth camera 110 obtains a depth image of an object located at the front, an initial image acquired by the depth camera 110 is a full body image of the user. Here, the hand shape depth image extracting unit 130 extracts only a depth image of the hand region.

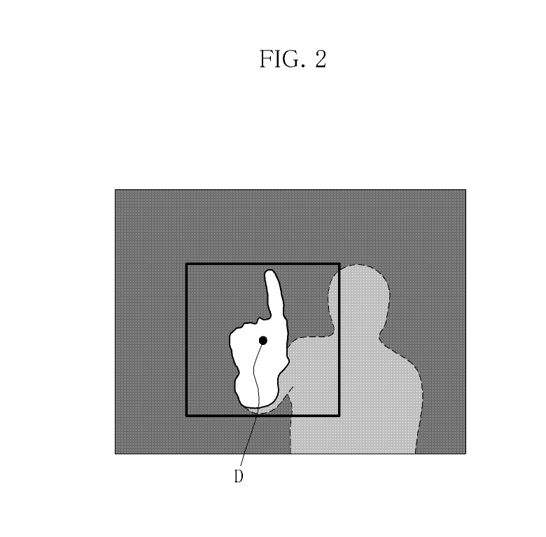

In detail, each pixel of an image has a single depth value, and the closer a subject is disposed to the depth camera 110, the smaller depth value the pixels for the subject have. Here, it is assumed that a pixel having a smaller depth value has greater brightness. FIG. 2 depicts a depth image of a user body photographed by the depth camera 110. Here, the hand is disposed closest to the depth camera 110 and thus has the greatest brightness, and the brightness is decreased in the order of a body of the user and a background. At this time, the hand shape depth image extracting unit 130 may extract the hand shape depth image from the depth image of a user body by extracting a figure including the hand region and circumscribing to an edge of the hand region. Even though FIG. 2 depicts that the circumscribing figure is rectangular, this figure may have other shapes such as polygons or a circle.

In order to extract the circumscribing figure, a pixel D having a smallest depth value is detected from a depth image of a user body, and a pixel having a depth value whose difference from the smallest depth value is within a preset range is detected. The preset range may be a difference between the depth value of the pixel D and a depth value of an edge pixel of the hand region.

Here, the size of the hand shape depth image may be determined depending on a diameter, a length of a side or a diagonal length of the circumscribing figure. For example, if the circumscribing figure is circular, the size of the hand shape depth image may be determined depending on the diameter of the circle. In addition, if the circumscribing figure is a square, the size of the hand shape depth image may be determined depending on a side length or diagonal length of the square. Moreover, the figure may be expressed with a predetermined image size.

The hand shape depth image normalizing unit 140 normalizes the extracted hand shape depth image with respect to a size, a direction or a depth value.

First, in relation to the size normalization, the hand shape depth image normalizing unit 140 enlarges or reduces the extracted hand shape depth image so that the extracted hand shape depth image has a preset size. For example, if a preset square image has a size of 40×40 pixels and a hand region image has a size of 70×70 pixels, length and width of the hand shape depth image may be reduced into the size of 40×40 pixels.

In addition, in relation to the direction normalization, the hand shape depth image normalizing unit 140 may normalize a direction of the extracted hand shape depth image by rotating the hand shape depth image so that the hand shape in the extracted hand shape depth image is disposed in a preset direction. For example, if the preset direction is an x-axis direction, the hand shape depth image normalizing unit 140 may rotate the hand shape depth image so that the hand shape is disposed in the x-axis direction. In an embodiment, the direction of the hand shape may be a dominant orientation of gradients of all pixels of the hand shape depth image, and the gradient of each pixel of the hand shape depth image is a vector representing a changing direction and size, or degree, of the depth values around on the corresponding pixel.

Subsequently, in relation to the depth value normalization, the hand shape depth image normalizing unit 140 adjusts depth values of the extracted hand shape depth image by changing all the depth values based on a smallest depth value of the image. In detail, all the depth values of the input hand shape depth image may be adjusted so that the smallest depth value in the depth image may have a specific value. For example, it is assumed that the pixel D having a smallest depth value in the rectangle depicted in FIG. 2 has a depth value of 9 and the other pixels have depth values greater than 9, such as 10, 12, 17 or the like. Here, if 9 which is the depth value of the pixel D is subtracted from the depth values of all pixels, depth values of the rectangle of FIG. 2 will be 0, 1, 3, 6 or the like, which is adjusted so that the smallest depth value is 0. By doing so, all depth values are adjusted for the input hand shape depth image, thereby completing the depth value normalization.

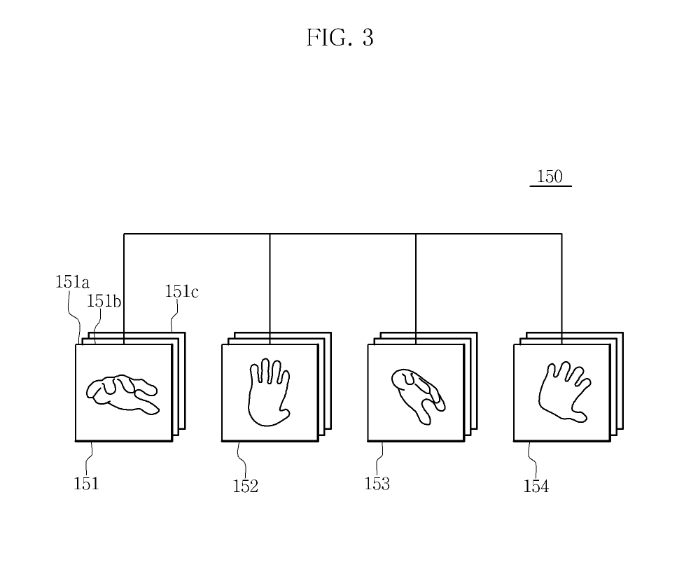

The database 150 stores the normalized hand shape depth images. In detail, the database 150 may store the hand shape depth images after classifying according to their depth values. FIG. 3 shows a structure of the database 150 in which hand shape depth images are classified according to depth values and stored. If hand shapes are similar or identical to each other, the hand shape depth images also have similar or identical depth values. Therefore, if hand shape depth images are classified depending on depth values, similar or identical hand shapes are classified into a single group. For example, if it is assumed that the database 150 is classified into a first group 151, a second group 152, a third group 153, and a fourth group 154, these groups are defined to include different hand shapes from each other, and the first group stores a plurality of similar or identical hand shape depth images 151a to 151c.

In addition, the database 150 may store information of hand joint angles corresponding to each hand shape depth image. The information about the hand joint angles is acquired by the hand joint angle acquiring unit 120 and stored as a pair with the corresponding hand shape depth image.

The database constructed as above allows a hand shape depth image input by a user to be detected more accurately and rapidly in the second embodiment of the present disclosure.

Hereinafter, a method and device of recognizing a hand shape according to the second embodiment of the present disclosure will be described in detail with reference of other drawings.

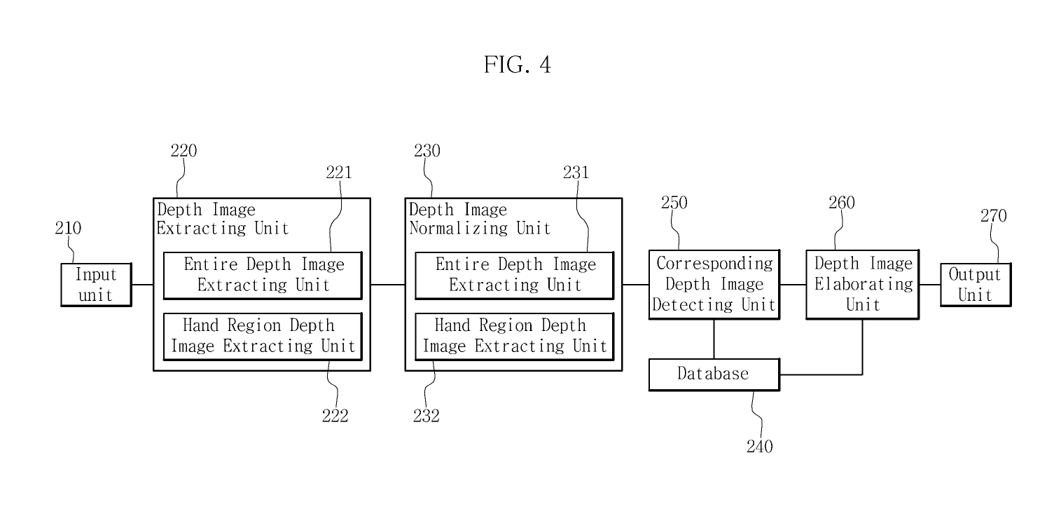

Referring to FIG. 4, a device of recognizing a hand shape (hereinafter, also referred to as a “hand shape recognizing device”) according to the second embodiment of the present disclosure includes an input unit 210, a depth image extracting unit 220, a depth image normalizing unit 230, a database 240, a corresponding depth image detecting unit 250, a depth image elaborating unit 260 and an output unit 270.

The input unit 210 receives a motion of a user. The user may input any hand motion or various other gestures through the input unit 210. The input unit 210 is configured with a camera to receive a motion of the user.

The depth image extracting unit 220 extracts a depth image for a hand region of the user from the motion of the user. For this purpose, the depth image extracting unit 220 includes an entire depth image extracting unit 221 and a hand region depth image extracting unit 222.

The entire depth image extracting unit 221 may be configured with a depth camera, and in this case, the entire depth image extracting unit 221 extracts a depth image of a user body photographed by the depth camera. For example, the entire depth image extracting unit 221 extracts a depth image of a face or an upper body of the user, which is close to the hand region, together with the hand region.

The hand region depth image extracting unit 222 extracts only a depth image for hand region from the depth image of the user body. The hand region depth image extracting unit 222 extracts a specific figure including the hand region, similar to the hand shape depth image extracting unit 220 of the first embodiment. The figure becomes the hand shape depth image. At this time, the figure is extracted as follows. If it is assumed that an actual hand of a human has a size like (length, width and thickness) mm=(w, h, d) mm, a depth image including the hand region may be extracted by extracting the pixels with depth values whose difference from the smallest depth value of the depth image of the user body is less than d mm. For example, assuming that the depth value of the pixel D in FIG. 2 has a smallest value of 200 mm, if d mm is set to be 150 mm, only pixels having depth values between 200 mm and 350 mm will be extracted. In addition, the specific figure including the hand region may be defined to have various shapes such as a circle or polygons, and the size of the hand shape depth image may be determined depending on a diameter, a side length or a diagonal length according to the shape of the figure.

The depth image normalizing unit 230 includes a size normalizing unit 231 and a depth value normalizing unit 232 and normalizes the extracted hand shape depth image according to a size and depth values. The normalizing process is required since the hand shape depth images stored in the database 240 are already normalized with respect to the size and depth value. The database 240 of the second embodiment will be described later in more detail.

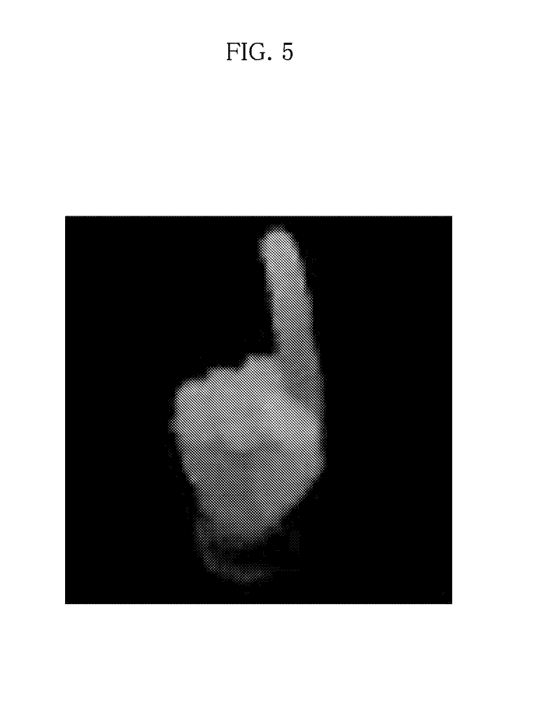

The size normalizing unit 231 enlarges or reduces the extracted hand shape depth image so that the extracted hand shape depth image has a preset size (namely, the size of the hand shape depth images stored in the database 240). The depth value normalizing unit 232 adjusts depth values of the hand shape depth image input by the user to conform to a criterion of depth values of the hand shape depth images stored in the database 240. In detail, if the hand shape depth images stored in the database 240 are normalized to have a smallest depth value of A, the depth value normalizing unit 232 adjusts the depth values of the hand shape depth image input by the user to meet the criterion of the depth value distribution of the hand shape depth images stored in the database 240. In other words, the depth value normalizing unit 232 adjusts the hand shape depth image input by the user to have a smallest depth value of A. The hand shape depth image normalized by the depth image normalizing unit 230 is depicted in FIG. 5.

The database 240 stores a plurality of normalized hand shape depth images. The stored hand shape depth images are normalized with respect to a size and depth values. For example, all hand shape depth images may be normalized to have an image size of 40×40 pixels and also have a smallest depth value of A. In addition, the database 240 may store the hand shape depth images after classifying according to their depth values, similar to the database of the first embodiment. In other words, as shown in FIG. 3, a plurality of hand shape depth images may be classified according to similar or identical hand shapes and stored in the database 240. In addition, the database 240 may store information of hand joint angles corresponding to each hand shape depth image. The database 240 is substantially identical to the database 150 of the first embodiment and is not described in detail here.

The corresponding depth image detecting unit 250 detects from the database 240 a hand shape depth image corresponding to the normalized hand shape depth image input by the user. The corresponding depth image detecting unit 250 may detect from the database 240 a depth image most similar to the hand shape depth image input by the user by determining similarity between depth values of the normalized hand shape depth image input by the user and the depth images stored in the database 240.

In detail, the corresponding depth image detecting unit 250 determines depth value similarity based on at least one of depth values, a gradient direction and a gradient magnitude of the hand shape depth images.

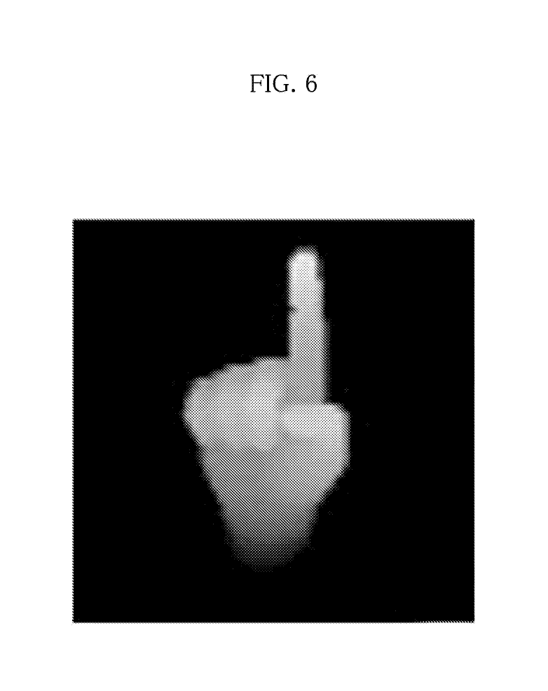

First, a process of determining depth value similarity based on depth values will be described. Each hand shape depth image is composed of a plurality of pixels, and a single depth value is defined to each pixel. The corresponding depth image detecting unit 250 compares depth values of all pixels of the normalized hand shape depth image input by the user with depth values of all pixels of the hand shape depth images stored in the database 240. Then, if the difference in depth values is within a preset range as a result of comparison, the corresponding depth image detecting unit 250 determines that both images are similar and detects from the database 240 a hand shape depth image whose depth values have the smallest difference. The detected hand shape depth image is shown in FIG. 6. Comparing FIG. 6 with FIG. 5, it may be found that the hand shape depth image depicted in FIG. 6 is very similar to the normalized hand shape depth image depicted in FIG. 5.

Subsequently, a process of determining depth value similarity based on a gradient direction and magnitude will be described. For each pixel of the hand shape depth image, a gradient representing a changing direction and size, or degree, of the depth values around the corresponding pixel may be calculated. Assuming that a certain pixel of the hand shape depth image has horizontal and vertical coordinates of x and y, I(x, y) represents a depth value of the corresponding pixel. At this time, by using x-directional differential and y-directional differential of the depth value at the corresponding pixel, the gradient may be expressed as ∇I(x,y)=(Iₓ,I_{y}). Here, the direction of the gradient I is defined as Equation 1, and the magnitude of the gradient I is defined as Equation 2.

$$\begin{matrix}θ = {tan}^{- 1} ( \frac{{I}_{y}}{{I}_{x}} ) , & Equation 1 \\ ‖ ∇ I ‖ = \sqrt{{I}_{x}^{2} + {I}_{y}^{2}} . & Equation 2\end{matrix}$$

Since the gradient is calculated using a difference in depth values of adjacent pixels, the gradient magnitude is larger as the difference in depth values of adjacent pixels is greater. Therefore, since a contour of a region between fingers has a great difference in depth values in the hand shape, such a contour has a great gradient magnitude in the hand shape. The information about the gradient direction and magnitude may also be expressed as an image.

The corresponding depth image detecting unit 250 determines depth value similarity by calculating gradients of the hand shape depth image input by the user and the hand shape depth images stored in the database 240, and comparing at least one of the direction and the magnitude of the calculated gradients. Then, if the difference in the direction or the magnitude of the compared gradients is within a preset range, the hand shape depth image may be detected as a depth image corresponding to the hand shape depth image input by the user. In other words, the corresponding depth image detecting unit 250 may extract gradient images of the hand shape depth image input by the user and the hand shape depth images stored in the database 240, determine similarity of the extracted images, and then detect the most similar image as the image corresponding to the hand shape depth image input by the user.

In an embodiment, the corresponding depth image detecting unit 250 may also detect the image corresponding to the hand shape depth image input by the user by using directions of gradients as follows. The corresponding depth image detecting unit 250 may calculate a dominant orientation of gradients of a pixel bundle composed of a plurality of pixels of the normalized hand shape depth image, and obtain a binary orientation for a pixel bundle based on the dominant orientations of pixel bundles surrounding the corresponding pixel bundle. By obtaining a binary orientation of each pixel bundle in this way, it is possible to generate a feature vector of the normalized hand shape depth image by generating a binary orientation histogram vector. Then, the corresponding depth image detecting unit 250 compares the feature vector of the hand shape depth image input by the user with feature vectors of the hand shape depth images stored in the database 240, and if any hand shape depth image has a difference in terms of feature vectors within a preset range, the hand shape depth image may be detected as a depth image corresponding to the hand shape depth image input by the user. At this time, the feature vector of the hand shape depth image input by the user may be compared with feature vectors of the hand shape depth images stored in the database by using the locality sensitive hashing.

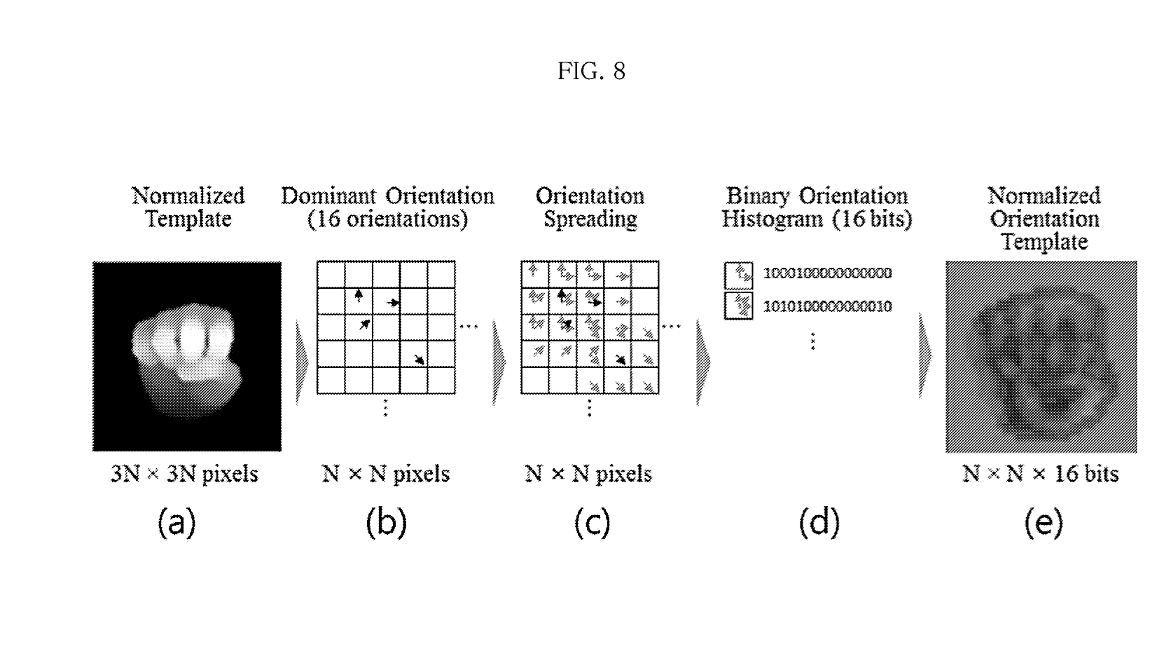

For example, in an embodiment of FIG. 8, for a normalized hand shape depth image (a) of 3N×3N pixels, a dominant orientation of gradients is calculated for each pixel bundle composed of 3×3 pixels (b). After that, for a single pixel bundle, dominant orientations of the corresponding pixel bundle and surrounding eight pixel bundles are applied to the binary orientation of the corresponding pixel bundle, and a binary orientation histogram vector representing 16 directions with 16 bits is generated by express an orientation included therein as 1 and an orientation not included therein as 0 (d). As a result, a normalized feature vector of N×N×16 (e) for the normalized hand shape depth image (a) is generated. After that, by comparing the generated feature vector (e) with feature vectors of the hand shape depth images stored in the database 240, the most similar depth image may be detected.

In addition, the corresponding depth image detecting unit 250 may not search the depth image similar to the depth image input by the user from all depth images stored in the database 240. Instead, the corresponding depth image detecting unit 250 may firstly detect a group most similar to the depth image input by the user from the database 240 and then detect the most similar depth image in the detected group, which ensures a very rapid detecting work.

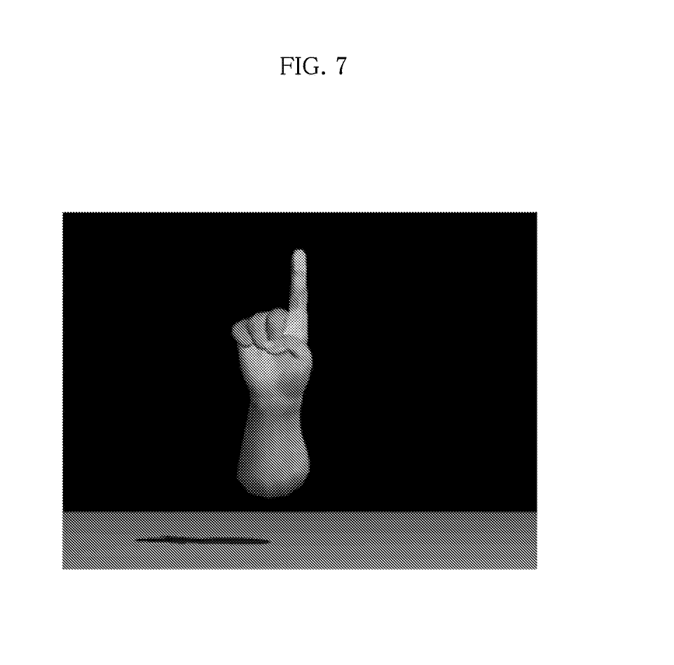

The depth image elaborating unit 260 detects information about hand joint angles corresponding to the detected hand shape depth image from the database 240 and expresses the hand shape depth image in more detail and concrete way. The hand shape depth image expressed in detail reproduces the input hand shape of the user as it is. The hand joint angle means an angle of a joint between hand bones. The hand shape depth image detected by the corresponding depth image detecting unit 250 does not include detailed information about a region between knuckles or the shapes of fingers as shown in FIG. 6. Therefore, the depth image elaborating unit 260 uses the information about hand joint angles as a means for adding more details to the detected hand shape depth image. In other words, the depth image elaborating unit 260 further processes the detected hand shape depth image so that the output may be more like the hand shape depth image input by the user. FIG. 7 shows an image representing the hand shape in more detail by overlapping the information of the hand joint angles on the image of FIG. 6. By employing the information about hand joint angles as above, a detailed hand shape depth image may be acquired.

The output unit 270 outputs the final hand shape depth image provided from the depth image elaborating unit 260. The output unit 270 may be configured with a means capable of visually showing a depth image such as a screen.

As described above, the second embodiment of the present disclosure allows a hand shape of a user to be recognized in a more rapid and accurate way in comparison to existing technologies by constructing a database including depth images of hand shapes so that an input hand shape may be recognized by using the database. In existing technologies, it takes long time to detect, and an error may easily occur during a tracking process. However, in an embodiment of the present disclosure, since a hand shape most similar to the input hand shape is detected from the database, the hand shape may be recognized rapidly. Further, since depth images stored in the database are classified into a plurality of groups in a tree structure, when detecting a depth image, it is sufficient to search a part of data according to the tree structure without searching the entire data. Therefore, the hand shape recognition rate may be further improved. In addition, in the embodiment of the present disclosure, a hand shape depth image may be provided more accurately and with more details by using depth images and information about hand joint angles stored in the database.

Even though embodiments of the present disclosure have been described in detail, it will be understood by those skilled in the art that many modifications or equivalents can be made therefrom.

Therefore, the scope of the present disclosure is not limited thereto, but various modifications and improvements made using the basic concept of the present disclosure defined in the appended claims by those skilled in the art should also be understood as falling within the scope of the present disclosure.

What is claimed is:

1. A method of establishing a database including hand shape depth images, comprising:
receiving a motion of a user;
extracting a hand shape depth image and hand joint angles of the user from the received motion;
normalizing a size and depth values of the extracted hand shape depth image; and
storing the normalized hand shape depth image with corresponding hand joint angles extracted.

2. The method of establishing the database including the hand shape depth images according to claim 1,
wherein the hand joint angles are angles of joints between phalanges.

3. The method of establishing the database including the hand shape depth images according to claim 1,
wherein said extracting of the hand shape depth image and the hand joint angles of the user from the received motion extracts a figure including a hand region of the user from a depth image of the motion of the user to obtain the hand shape depth image.

4. The method of establishing the database including the hand shape depth images according to claim 3, wherein said normalizing includes:
determining a size of the hand shape depth image by using at least one of a diameter, a length of a side and a diagonal length of the extracted figure;
comparing the size of the hand shape depth image with a preset size; and
adjusting the size of the hand shape depth image to the preset size by enlargement or reduction.

5. The method of establishing the database including the hand shape depth images according to claim 3, wherein said normalizing includes:
adjusting a smallest depth value in the extracted hand shape depth image to a specific value so that the stored hand shape depth images have the same smallest depth value; and
adjusting other depth values in the hand shape depth image according to an adjustment degree of the smallest depth value.

6. The method of establishing the database including the hand shape depth images according to claim 1, further comprising:
normalizing a direction of the extracted hand shape depth image.

7. A method of recognizing a hand shape by using a database including a plurality of hand shape depth images, the method comprising:
receiving a motion of a user;
extracting a hand shape depth image of the user from the received motion;
normalizing a size and depth values of the extracted hand shape depth image to conform to criteria of a size and depth values of the hand shape depth images stored in the database; and
detecting from the database a hand shape depth image corresponding to the normalized hand shape depth image.

8. The method of recognizing the hand shape according to claim 7,
wherein said extracting of the hand shape depth image of the user from the received motion detects an image having depth values within a preset range from the depth image of the motion of the user and extracts a figure including a hand region of the user as the hand shape depth image.

9. The method of recognizing the hand shape according to claim 8,
wherein the hand shape depth images stored in the database are normalized to have a preset size, and the depth values of the hand shape depth images stored in the database are normalized based on a smallest depth value of each hand shape depth image.

10. The method of recognizing the hand shape according to claim 9, said normalizing includes:
normalizing the size of the hand shape depth image by adjusting a size of the figure to the preset size by enlargement or reduction; and
normalizing the depth values of the hand shape depth image by adjusting all depth values of the figure so that a smallest depth value of the figure is identical to the smallest depth value of the hand shape depth images stored in the database.

11. The method of recognizing the hand shape according to claim 7,
wherein said detecting of the hand shape depth image corresponding to the normalized hand shape depth image from the database detects from the database a hand shape depth image with depth values whose difference from the depth values of the normalized hand shape depth image is within a preset range.

12. The method of recognizing the hand shape according to claim 11,
wherein said detecting of the hand shape depth image corresponding to the normalized hand shape depth image from the database determines a difference in depth values between the normalized hand shape depth image and the hand shape depth images stored in the database based on at least one of depth values, a gradient direction and a gradient magnitude.

13. The method of recognizing the hand shape according to claim 12,
wherein said detecting of the hand shape depth image corresponding to the normalized hand shape depth image from the database determines the difference in the depth values by comparing depth values of pixels in the normalized hand shape depth image and depth values of pixels in the hand shape depth images stored in the database corresponding to the pixels in the normalized hand shape depth image.

14. The method of recognizing the hand shape according to claim 12, wherein said detecting of the hand shape depth image corresponding to the normalized hand shape depth image from the database includes:
calculating a direction and a magnitude of a gradient of the normalized hand shape depth image and directions and magnitudes of gradients of the hand shape depth images stored in the database;
comparing at least one of the directions and the magnitudes between the gradient of the normalized hand shape depth image and the gradients of the hand shape depth images stored in the database; and
detecting from the database a hand shape depth image with gradients whose direction or magnitude has a difference from the direction or the magnitude of the gradient of the normalized hand shape depth image within the preset range.

15. The method of recognizing the hand shape according to claim 10,
wherein the database includes information about hand joint angles corresponding to each hand shape depth image, and
wherein the method further comprises elaborating the detected hand shape depth image by using information about hand joint angles corresponding to the detected hand shape depth image.

16. The method of recognizing the hand shape according to claim 7, further comprising:
normalizing a direction of the extracted hand shape depth image to conform to a direction criterion of the hand shape depth images stored in the database.

17. A device of recognizing a hand shape, comprising:
an input unit configured to receive a motion of a user;
a depth image extracting unit configured to extract a hand shape depth image of the user from the received motion;
a database storing a plurality of hand shape depth images;
a depth image normalizing unit configured to normalize a size and depth values of the extracted hand shape depth image to conform to criteria of a size and depth values of the hand shape depth images stored in the database; and
a corresponding depth image detecting unit configured to detect from the database a hand shape depth image corresponding to the normalized hand shape depth image.

18. The device of recognizing the hand shape according to claim 17,
wherein the depth image extracting unit detects an image having depth values within a preset range from the depth image of the motion of the user and extracts a figure including a hand region of the user as the hand shape depth image.

19. The device of recognizing the hand shape according to claim 18,
wherein the hand shape depth images stored in the database are normalized to have a preset size, and the depth values of the hand shape depth images stored in the database are normalized based on a smallest depth value of each hand shape depth image.

20. The device of recognizing the hand shape according to claim 19, wherein the depth image normalizing unit includes:
a size normalizing unit configured to normalize the size of the hand shape depth image by adjusting a size of the figure to the preset size by enlargement or reduction; and
a depth value normalizing unit configured to normalize the depth values of the hand shape depth image by adjusting all depth values of the figure so that a smallest depth value of the figure is identical to the smallest depth value of the hand shape depth images stored in the database.

21. The device of recognizing the hand shape according to claim 17,
wherein the corresponding depth image detecting unit detects from the database a hand shape depth image with depth values whose difference from the depth values of the normalized hand shape depth image is within a preset range.

22. The device of recognizing the hand shape according to claim 21,
wherein the corresponding depth image detecting unit determines a difference in depth values between the normalized hand shape depth image and the hand shape depth images stored in the database based on at least one of depth values, a gradient direction and a gradient magnitude.

23. The device of recognizing the hand shape according to claim 22,
wherein the corresponding depth image detecting unit determines the difference in the depth values by comparing depth values of pixels in the normalized hand shape depth image and dep values of pixels in the hand shape depth images stored in the database corresponding to the pixels in the normalized hand shape depth image.

24. The device of recognizing the hand shape according to claim 22, wherein the corresponding depth image detecting unit performs:
calculating a direction and a magnitude of a gradient of the normalized hand shape depth image and directions and magnitudes of gradients of the hand shape depth images stored in the database;
comparing at least one of the directions and the magnitudes between the gradient of the normalized hand shape depth image and the gradients of the hand shape depth images stored in the database; and
detecting from the database a hand shape depth image whose gradient has a direction or a magnitude within the preset range.

25. The device of recognizing the hand shape according to claim 17,
wherein the database includes information about hand joint angles corresponding to each stored hand shape depth image, and
wherein the device further comprises a depth image elaborating unit configured to elaborate the detected hand shape depth image by using information about hand joint angles corresponding to the detected hand shape depth image.

26. The device of recognizing the hand shape according to claim 17,
wherein the depth image normalizing unit further normalizes a direction of the extracted hand shape depth image to conform to a direction criterion of the hand shape depth images stored in the database.
